(19) United States
(12) Patent Application Publication
(10) Pub. No.: US 2026/0017102 A1
(43) Pub. Date: Jan. 15, 2026

(54) DIRECTIONAL SCHEDULING WITHIN A GENETIC ALGORITHM

(71) Applicant: nMetric, LLC, Dallas, TX (US)

(72) Inventors: Christine Koski, Dallas, TX (US); Stephen Cook, Albuquerque, NM (US)

(21) Appl. No.: 18/771,933

(22) Filed: Jul. 12, 2024

(51) Int. Cl. G06F 9/50; G06N 3/126

(52) U.S. Cl. CPC G06F 9/5027; G06N 3/126

(57) ABSTRACT

Systems and methods in which a scheduling computing system reduces the computational load required by a computing device to generate a schedule by generating a schedule of tasks within a genetic algorithm using directional scheduling within the genetic algorithm. To do so, the computing device is programmed to obtain a plurality of jobs and determine whether the jobs can be backward scheduled. If so, the computing device fits the job, task by task, into the schedule via backward scheduling.

### FIELD OF THE INVENTION

The field of the invention is computer-based scheduling systems.

### BACKGROUND

The background description includes information that may be useful in understanding the present invention. It is not an admission that any of the information provided herein is prior art or relevant to the presently claimed invention, or that any publication specifically or implicitly referenced is prior art.

In real-world scheduling, due dates are often mandatory and are what differentiate a good schedule from a bad one. Thus, scheduling systems try to address the issue of due dates when many different schedules are possible.

Current genetic algorithm-based scheduling systems tend to try to schedule as much as possible towards the front/beginning of the schedule. However, this can result in a situation where many of the jobs are done too early: this can be disruptive to jobs/processes happening down the line which actually then can make other jobs be completed too late; additionally, this approach can result in too much inventory/output being created, which creates the problem of what to do with all of this output in the time before the next steps can begin or the product can be moved.

Another approach is backward scheduling from a due date. Backward scheduling involves scheduling from a due date and then working backward toward the present. However, one challenge with backward scheduling is that, depending on the tasks being arranged, certain tasks can actually be scheduled to start in the past because the jobs may not fit.

Thus, there is still a need for a computer-based scheduling system that is capable of generating schedules for maximum on-time completion within a minimum of inventory build or other problems due to early completion.

### SUMMARY OF THE INVENTION

The inventive subject matter provides apparatus, systems and methods in which a scheduling computing system reduces the computational load required by a computing device to generate a schedule by generating a schedule of tasks within a genetic algorithm using directional scheduling within the genetic algorithm. To do so, the computing device is programmed to obtain a plurality of jobs and determine whether the jobs can be backward scheduled. If so, the computing device fits the job, task by task, into the schedule via backward scheduling.

If at any point the computing device determines that the rest of the job cannot be backward schedule, it can force forward-schedule the remainder of the job or, alternatively, the entirety of the job.

The computing device can do this for a plurality of jobs sequentially (e.g., job by job) or first generate a genome and then proceed with the process to schedule the tasks as arranged within the genome.

Upon generating the schedule, the computing device can cause the execution of the tasks in the genome according to the schedule.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIGS. 1A and 1B are an example of an assembly of a genome from a plurality of jobs, according to embodiments of the inventive subject matter.

FIG. 2 is a flowchart illustrating the processes executed by a computing device, according to embodiments of the inventive subject matter.

FIG. 3 shows a visual example of job 110 of FIG. 1A with all of its tasks inserted into the schedule via backward scheduling assuming 100% availability, according to embodiments of the inventive subject matter.

FIG. 4 provides a flowchart of how the computing device can backward-schedule the tasks in a job at step 240, according to embodiments of the inventive subject matter.

FIG. 5A illustrates the insertion via backward-scheduling of task 125 from job 120 into the schedule that already has all of job 110 inserted via backward-scheduling, according to embodiments of the inventive subject matter.

FIG. 5B illustrates the insertion via backward-scheduling of task 124 from job 120 into the schedule generated in FIG. 5A, according to embodiments of the inventive subject matter.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

A computer-based scheduling system can account for one or more types of scheduling problems that can be based on factors such as the type of organization, the type of jobs and/or tasks involved, available times, etc. Some examples of the types of scheduling problems these systems are expected to handle include:

Open shop scheduling. In open shop scheduling, each job has a task on each available machine, without any types of ordering constraints. Thus, the tasks can be performed in any order. Typically, there's no parallel work on a job.

Flow shop scheduling: In flow shop scheduling, each job has a task on each machine. Unlike open shop scheduling, the order of the tasks matters in flow shop scheduling.

Permutation flow shop: Permutation flow ship is similar to flow shop scheduling, but the machine must perform the jobs (and the tasks therein) in the same order.

Job shop (“JSP”) scheduling, also known as Job-Shop Scheduling Problem (“JSSP”): the goal for JSP is to minimize “makespan”. This means that the goal for JSP is to compress the schedule as much as possible.

Flexible job shop (“FJSP”) scheduling: This is similar to the job shop scheduling, but the resources are interchangeable.

Truthful job scheduling: The resources available can perform any task in the job, but they take different time. For example, the resources can include personnel that have different skill levels at performing the task.

One challenge that computer-implemented scheduling systems face is that schedule generation for many jobs having many tasks is an “NP-hard” problem. For example, an open shop scheduling problem with “n” jobs and “m” resources has (n!)^{m} possible combinations. For 10 jobs with 10 resources, that means 3.95*10⁶⁵ possible schedules.

While scheduling types with more restrictions have a lower potential amount of schedules, the combinations are still staggering and simply too many for a computer system to brute force a “best” schedule.

Current systems use simple heuristic deterministic scheduling algorithms:

R (Random)—Pick any Job in Queue with equal probability. This rule is often used as benchmark for other rules.

FCFS (First Come First Serve)—Jobs are processed in the order in which they arrived at the work center (also called earliest release date)

SPT (Shortest Processing Time)—This rule tends to reduce both work-in-process inventory, the average job completion (flow) time, and average job lateness. SPT can also be used to break ties.

EDD (Earliest Due Date)—Choose Job that has earliest due date.

CR (Critical Ratio)=Processing Time/Time until due (Due Date−Current Time). Take the highest value.

LWR (Least Work Remaining)—This rule is an extension of SPT variant that considers the number of successive operations.

ST (Slack Time)=Time until job is due−(Sum of processing time remaining). Take the job with the smallest amount of slack time.

ST/O (Slack Time per Remaining Operation)=slack time divided by number of operations remaining. Take the job with the smallest amount of slack time per remaining Operation.

Existing systems have also employed more “complex” scheduling heuristics, such as Johnson's Algorithm (that uses Bellman-Ford), Kusiak's Algorithm, Palmer's Algorithm, Gupta's Algorithm, Shifting Bottleneck Algorithm, Campbell-Dudek-Smith (“CDS”) Algorithm, and/or Nawas-Enscore-Ham (“NEH”) Algorithm.

However, for the most part these all simply employ variations and/or combinations of the simple heuristics. While these approaches may get acceptable results in a human-scale amount of time, none are guaranteed to find optimal solutions.

Existing scheduling systems employ fitness functions that use common variables such as processing time, release date, due date, weight, lateness, makespan, and release date. Common fitness functions will then return “raw” fitness scores that can be combined with user-supplied specific factors to weight the fitness scores. For example, an output of the fitness function can be a measure of robustness, which reflects the sensitivity of the schedule to problems/interruptions in a flow. Typically, to improve robustness, a system can add idle times, schedule less flexible jobs first, and forward-schedule as many tasks as possible. In another example, the output of the fitness function can be a measure of tightness, which minimizes the absolute size of the lateness.

The processes discussed here are discussed as being performed by a computing system or computing device. A computing system/device can be considered to be comprised of one or more hardware computer systems having one or more processors, non-transitory memory (RAM, ROM, etc.), communication interfaces allowing the computing system to exchange data with other computing systems (e.g., via internet, cellular, etc.) and with I/O interfaces that can allow a user to interact with the device.

As discussed herein, a job is made up of tasks. Tasks are discrete functions or processes that are the subparts of a job. The tasks of a job are often sequential such that one or more tasks may need to be completed for a subsequent one or more tasks of a job to start.

A task requires one or more resources to complete. A resource can be anything that a task may need to be completed. Examples of resources can include equipment, personnel, locations, etc.

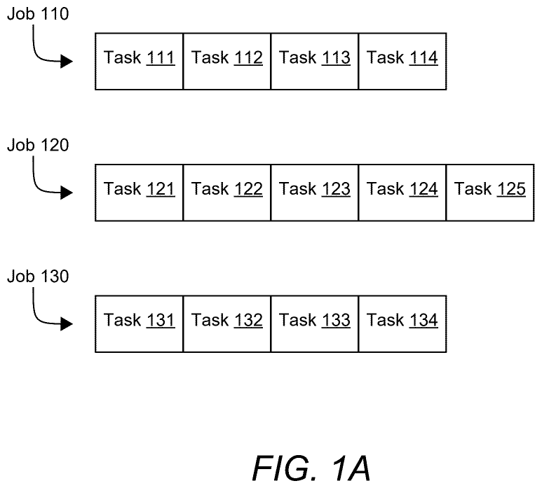

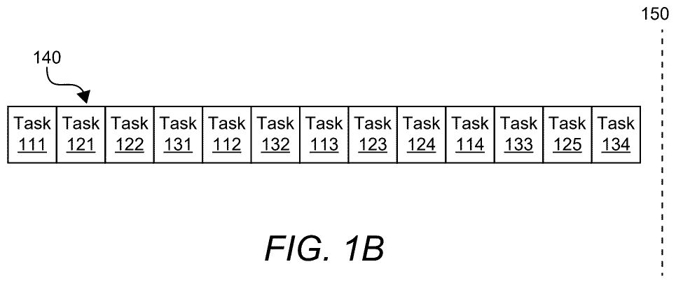

A genome as discussed herein can be considered to be a list of tasks. In the examples discussed herein, a genome can include all of the tasks from all of the jobs associated with an organization or a process within an organization. An example of the assembly of a genome is seen in FIGS. 1A and 1B.

FIG. 1A illustrates a plurality of jobs 110, 120, 130 with their respective tasks organized sequentially according to the job. Thus, job 110 will have task 1 (block 111), task 2 (block 112), task 3 (block 113) and task 4 (block 114) that need to be performed for job 110 to be completed. Likewise, job 120 has tasks 1-5 (blocks 121-125, respectively) and job 130 has tasks 1-4 (blocks 131-134, respectively).

To create a genome, a computing device gets all the tasks associated with all of the jobs and mixes them up to create a list from all of these tasks. FIG. 1B shows an example of a genome 140 created from all of the tasks of jobs 110, 120 and 130. Generally speaking, the tasks can be mixed up in almost any order, though the assembly of a genome can be subject to rules. For example, one rule of a genome is that the tasks must be for any job along the length of the genome. This means that while the tasks of a genome are not required to be consecutive or next to one another, a task for a job cannot precede an earlier task from the same job. Thus, in this example, task 3 (block 113) of job 110 cannot be before task 2 (block 112) of the same job 110 within the assembled genome 140. FIG. 1B also illustrates a deadline/due date 150 (illustrated via the dotted line) for completion of the genome 140. The significance of the due date 150 as it pertains to the inventive subject matter will be explained in further detail below.

In the example of FIGS. 1A, 1B, the schedule is then generated simply by taking the genome 140 in the order and assigning the tasks in the genome for execution. The creating of the schedule can also include matching resources with the different tasks of the genome 140.

If the genome 140 is generated via forward-scheduling, then the first task 111 is assembled into the genome 140 first with a start time of a present time (also called the “nowline”) or starting at a scheduled future time (a virtual “nowline”), with the rest of the tasks in the genome 140 added sequentially from this present time task into the future. Thus, because of the nature of the earlier tasks, the exact timing of the later tasks including final task 134 will not be known until they are added to the genome 140 and the final ending of task 134 could be past a deadline or due date 150 (illustrated here by the dotted line).

If the genome 140 is purely backward-scheduled, then the last task 134 is added to the schedule first starting at a deadline and then working chronologically backward whereby the computing device then schedules tasks 125, 133, 114, etc., working its way toward the present time. In this situation, one possible outcome is that one or more of the earlier tasks (111, 121, 122, etc.) could actually be scheduled to start at a time in the past, which is physically impossible to execute.

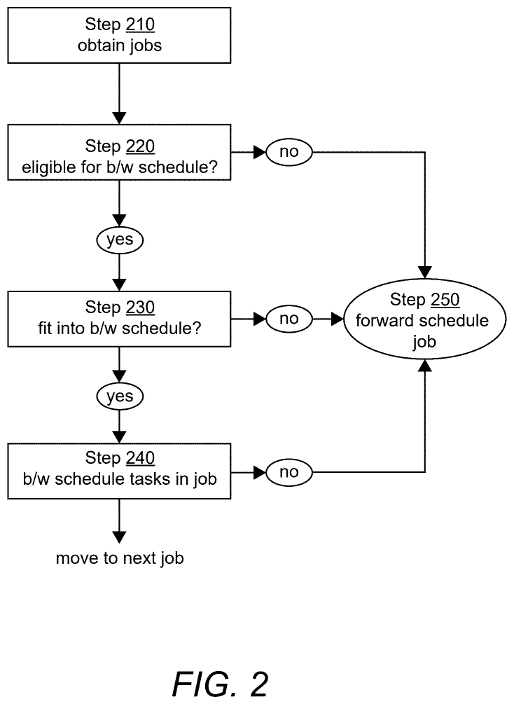

FIG. 2 is a flowchart illustrating the processes executed by a computing device, according to embodiments of the inventive subject matter.

At step 210, the computing device obtains a plurality of jobs, each of the jobs comprising a plurality of tasks that must be completed to complete the respective job.

At step 220, the computing device first initializes all of the jobs to be backward-scheduled. Thus, at step 220, the computing device determines whether each job can be backward scheduled before considering the tasks within a job. For some jobs, the start may be dependent on a factor that cannot be delayed, so the job as a whole may be prohibited from backward-scheduling. The job as a whole might have rules preventing backward scheduling, within a job can be backward-scheduled.

In embodiments of the inventive subject matter, each job and/or an assembled genome can include an additional gene. The additional gene contains information as to whether the job and/or genome can or must be backward-scheduled. In embodiments, the gene can be a bit added to the genome. In these embodiments, the computing device checks the additional bit at step 220 to determine whether a job can be backward scheduled.

If a job is not eligible for backward scheduling at step 220, the computing device force-forward schedules the job starting from a nowline (which can be an actual nowline denoting a present time or a virtual nowline).

Based on a determination that a job is eligible for backward scheduling at step 220, the computing device then determines whether the job will fit into a schedule with the backward scheduling at step 230, assuming 100% availability of the time available before the deadline/due date 150.

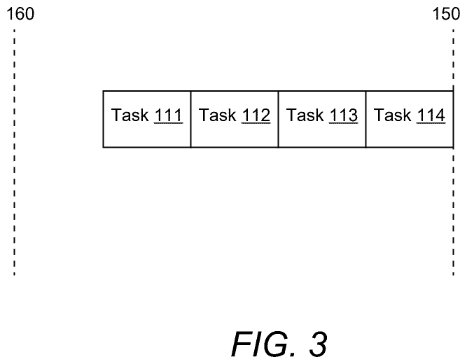

To do so, the computing device places the entire job, made up of all of its tasks, into the schedule timeline starting at the due date 150 and working back toward the present. FIG. 3 shows a visual example of job 110 of FIG. 1A with all of its tasks inserted into the schedule via backward scheduling assuming 100% availability. In this example, assuming 100% availability can include inserting the job 110 into the schedule without the presence of any other jobs or tasks (even if those were previously inserted into a schedule). As is seen in FIG. 3, the end of task 114 of job 110 ends at the due date 150. In this example, the start of the first task 111 of job 110 is after the nowline 160, with space existing between the nowline 160 (which could be the present time or a future date/time) and the start of task 111.

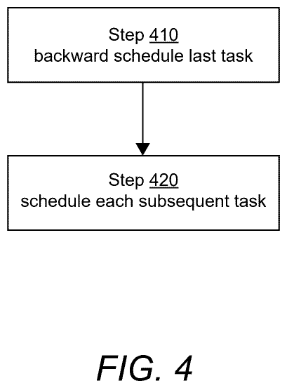

At step 240, the computing device begins to backward-schedule the job on an individual task basis based on the determination that the job can fit in the schedule. FIG. 4 provides a flowchart of how the computing device can backward-schedule the tasks in a job at step 240, according to embodiments of the inventive subject matter.

At step 410, the computing device schedules the last task in the job, first, starting at the job due date. In the example genome 140 of FIG. 1B, this would be task 11 for job 110, task 125 for job 120 or task 134 for job 130.

At step 420, the computing device then takes each subsequent task within the job and schedules the last tasks (those that are to be performed the latest in the job from the remaining tasks) first starting from the previously-scheduled task. Thus, from the last task that was scheduled first at step 410, the computing device looks for the next-to-last task that can be backward scheduled and schedules the next-to-last task to occur just before the already-backward-scheduled last task. This process would be repeated for each task remaining starting with the latest-available task.

The execution of step 420 can include the following subprocess:

For each task added to the schedule, the computing device can determine (at the time of adding the task to the schedule), whether the task to be added fits before a “nowline” or dispatch line. The nowline (illustrated as nowline 160 in FIG. 3) can be a time representing the current time, or a time of a point of no return for the job. If the task does not fit via backward scheduling before the nowline/dispatch line, the computing device force-forward schedules the task from the nowline/dispatch line.

The astute reader will appreciate that the first job that is backward-scheduled will be added to an empty schedule. As such, if this first job fits into the schedule at step 230, it will also fit with all of its tasks at step 240.

When adding a job to a schedule timeline that already has tasks of a job added, the computing device must take into account the tasks of the jobs already in the schedule as well as those of the job being added. Thus, at steps 410 and 420, the computing device reviews, for each task of a job being added, the task of the job being added, and the tasks of the job already added via backward scheduling.

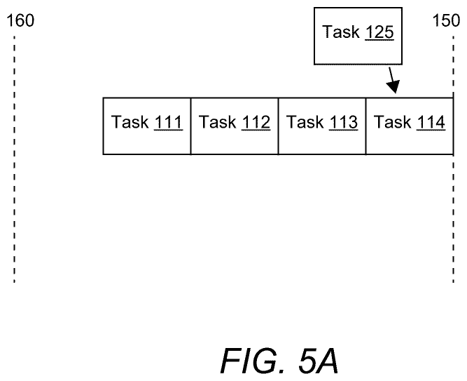

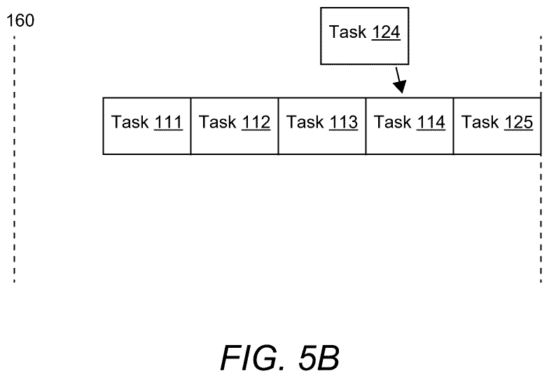

FIG. 5A illustrates the insertion via backward-scheduling of task 125 from job 120 into the schedule that already has all of job 110 inserted via backward-scheduling. At step 410, the computing device looks to add task 125 via backward-scheduling. In order to do so, the computing device first checks if inserting it via backward-scheduling will cause any part of job 110 to go past the nowline 160. Following this check, the computing device can insert task 125 anywhere as long as it's as close to the due date 150 as possible. To do so, the computing device can be programmed to check one or more priority rules to determine where the task 125 can be inserted or, conversely, how much of job 110 can be “pushed” toward the nowline 160 to accommodate task 125. The priority rules can include rules indicating a priority of the completion of the job via backward scheduling, task priorities based on equipment or other resource availabilities, or other considerations.

In this case, the priority rules are assumed to indicate that task 125 can be closer to the due date 150 than any of the tasks 111-114 of job 110, so it is inserted at the “end” of the current schedule. The insertion of task 125 is seen on FIG. 5B. Also visible in FIG. 5B is the next task to be backward scheduled—task 124 of job 120. Repeating step 420, and also as discussed above with regard to task 125, the computing device will repeat the process of checking how close to the due date 150 the task 124 can be inserted without causing a problem with the tasks of job 110 and with respect to the priority rules.

Returning to FIG. 2, if at any of step 220, step 230 or step 240 the computing device determines the job cannot be backward-scheduled, it forward-schedules the job at step 250. To do so, the computing device first determines whether the job will fit into the schedule with the forward-scheduling. This step is similar to step 230 in that the computing device determines whether the job can be forward scheduled with 100% availability. If not, then the computing device can return a message to a user indicating the scheduling is impossible.

If the job can be forward-scheduled at step 250, the job is then inserted into the schedule via forward scheduling task-by-task in a process mirroring step 240 in that each task is checked to see whether it can fit into the schedule given already-inserted jobs/tasks. If at any point the computing device determines that a task can no longer be inserted into the schedule via forward-scheduling, it proceeds to report to a user that the job cannot be scheduled in the current schedule given the other tasks/jobs already in the schedule.

In embodiments of the inventive subject matter, a job can include a fixed task (otherwise referred to as a pinned task). A fixed task is a task that has a set place within the job and thus, has a non-adjustable time or place within a schedule. The fixed task must be scheduled at a particular point in the job. This may be because the fixed task represents a bottleneck or an absolute requirement for subsequent task of the job to be completed. In these situations, the computing device checks the job(s) to be scheduled for fixed tasks first.

For each job having a fixed task, the computing device first inserts the fixed task and then proceed to first attempt to backward schedule a job by backward-scheduling all tasks before the fixed task using the fixed tasks as a due date for the preceding tasks of the job. To do so, the computing device can repeat the processes discussed above, using the fixed task as the due date for the tasks preceding the fixed task. For tasks following the fixed task, the computing device backward-schedules the tasks using the actual due as discussed above.

Where multiple jobs have fixed tasks, the computing device can, in embodiments, insert all fixed tasks across all jobs into the schedule first, and then insert each job as discussed above. In other embodiments, the computing device handles the integration of the jobs into the schedule on a job-by-job basis, including the fixed tasks, in the manner discussed above.

The embodiments of the inventive subject matter discussed above consider the computing device assembling a schedule genome via backward scheduling by taking each job individually and constructing the genome within the schedule as it backward or forward schedules each task in each job.

In alternative embodiments of the inventive subject matter, the computing device can first construct the genome 140 of FIG. 1B with all of the tasks of all of the jobs 110-130, and then proceed to perform the scheduling as discussed above with the genome 140 taken as one big job. In this way, the computing device performs the steps of FIGS. 2 and 4 with each of the tasks as arranged within genome 140 to generate the schedule.

Once the schedule has been fully generated, the computing device can cause the execution of the scheduled genome from the earliest task and then progressing down the genome. The execution can include sending instructions to other computing devices and/or machinery used in the execution of the tasks within the scheduled jobs.

By now, the astute reader can appreciate that the systems and methods of the inventive subject matter provide tangible technical improvements over existing computer-based scheduling systems because purely forward- or backward-scheduling has a rigidity that is wasteful of computer resources. In purely forward- or backward-scheduling systems, the computing device must re-run the entire creation of the genome and the schedule if the scheduling does not work or generate a satisfactory schedule. The flexibility to change between backward and forward scheduling reduces the need to restart the process from scratch, preserving computing time and resources by the computing system.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system of reducing computational load of generating schedules via directional scheduling within a genetic algorithm, comprising a processor programmed to:
obtain a plurality of jobs, each of the plurality of jobs including a plurality of tasks;
for each of the plurality of jobs:
determine whether the job can be backward-scheduled;
based on determining that the job can be backward-scheduled, determine whether the job will fit in a schedule with the backward-scheduling;
upon determining that the job can be backward-scheduled and that it will fit the schedule, backward-schedule the job;
upon determining that the job cannot be backward-scheduled, forward-schedule the job;
determine whether the job will fit the schedule; and
upon determining that the job will not fit the schedule, forward-schedule the job;
generate the schedule from the plurality of jobs according to the forward-scheduling or backward-scheduling of each of the jobs; and
cause the execution of the tasks within the generated schedule.

2. The system of claim 1, wherein backward-scheduling the job comprises:
schedule the last task in the job to be executed first starting at the job due date; and
for each subsequent task in the job, continue scheduling the last tasks first from the latest possible execution date of the task based on a prior-schedule task.

3. The system of claim 2, further comprising:
for each task added to the schedule, determine at the time of adding the task to the schedule whether the task fits before a nowline or dispatch line; and
upon determining that a task within the series of tasks does not fit before the nowline or the dispatch line, forward schedule the task from the nowline or the dispatch line.

4. The system of claim 1, wherein each genome includes an additional gene.

5. The system of claim 4, wherein the additional gene comprises a bit added to the genome.

6. The system of claim 1, wherein a task from one of the plurality of jobs comprises a pinned task, and wherein the backward-scheduling comprises backward-scheduling the job from the start of the pinned task within the schedule.

7. A method for reducing computational load of generating schedules via directional scheduling within a genetic algorithm, comprising:
obtaining, by at least one processor, a plurality of jobs, each of the plurality of jobs including a plurality of tasks;
for each of the plurality of jobs:
determining, by the at least one processor, whether the job can be backward-scheduled;
based on determining that the job can be backward-scheduled, determining, by the at least one processor, whether the job will fit in a schedule with the backward-scheduling;
upon determining that the job can be backward-scheduled and that it will fit the schedule, backward-scheduling, by the at least one processor, the job;
upon determining that the job cannot be backward-scheduled, forward-scheduling, by the at least one processor, the job;
determining, by the at least one processor, whether the job will fit the schedule;
upon determining that the job will not fit the schedule, forward-scheduling, by the at least one processor, the job; and
generating, by the at least one processor, the schedule from the plurality of jobs according to the forward-scheduling or backward-scheduling of each of the jobs.

8. The method of claim 7, wherein backward-scheduling the job comprises:
scheduling, by the at least one processor, the last task in the job to be executed first starting at the job due date; and
for each subsequent task in the job, continuing scheduling, by the at least one processor, the last tasks first from the latest possible execution date of the task based on a prior-schedule task.

9. The method of claim 8, further comprising:
for each task added to the schedule, determining, by the at least one processor, at the time of adding the task to the schedule whether the task fits before a nowline or dispatch line; and
upon determining that a task within the series of tasks does not fit before the nowline or the dispatch line, forward scheduling, by the at least one processor, the task from the nowline or the dispatch line.

10. The method of claim 7, wherein each genome includes an additional gene.

11. The method of claim 10, wherein the additional gene comprises a bit added to the genome.

12. The method of claim 7, wherein a task from one of the plurality of jobs comprises a pinned task, and wherein the backward-scheduling comprises backward-scheduling, by the at least one processor, the job from the start of the pinned task within the schedule.
